(19) United States
(12) Patent Application Publication
(10) Pub. No.: US 2017/0075904 A1
(43) Pub. Date: Mar. 16, 2017

(54) SYSTEM AND METHOD OF EXTRACTING LINKED NODE GRAPH DATA STRUCTURES FROM UNSTRUCTURED CONTENT

(71) Applicant: EDGETIDE LLC, Hanover, MD (US)

(72) Inventor: Jason Hedges, Pasadena, MD (US)

(73) Assignee: EDGETIDE LLC, Hanover, MD (US)

(21) Appl. No.: 14/856,202

(22) Filed: Sep. 16, 2015

(51) Int. Cl. G06F 17/30

(52) U.S. Cl. CPC G06F 17/3071; G06F 17/30958; G06F 17/30684

(57) ABSTRACT

The system and method of the present disclosure relates to automatically extracting linked node graph data structures from unstructured content. A configurable semantic natural NLP extraction platform structures content from unstructured data to determine the sematic meaning of content. Users generate configurations for an area or topic of interest, and query the system with the configuration to extract content from unstructured content. Based on the extracted content, an ontology is constructed for entities and activities, and entity and activity objects are identified within the unstructured content by applying a set of content extraction entity and activity rules. Application of the rules results in generation of a list of entity and activity words that satisfy the respective rules. Relationships between the entity and activity words are identified, and a linked data structure is formed as the linked node graph data structure.

### BACKGROUND

Natural language processing (NLP) is a field of computer science, artificial intelligence, and linguistics concerned with the interactions between computers and human (natural) languages. NLP is related to the area of human—computer interaction in which a computer captures meaning from unstructured text, such as documents, text, etc. However, many challenges in NLP involve natural language understanding, i.e. enabling the computers to derive meaning from human or natural language input.

Human or natural languages describe entities and activities and their relationship to each other. Whether someone is describing a complex scientific reaction between particles or the latest blockbuster movies, they are describing entities and activities or things and things that are happening. Machine languages, on the other hand, describe logic, processes, and algorithms. Thus, computer systems excel with structured data where they can easily use within computer programs, apply statistical models, easily search and discover the data, and display to a user in a variety of formats. However, much of the data that humans create is unstructured. This creates a gap between the majority of data and the type of data a computer system excels with.

As computer systems advance, so too does the amount of unstructured data within the digital world and, consequently, organizations. It is currently estimated that unstructured information accounts for approximately 70-90% of the data within most organizations. Despite the overwhelming majority of unstructured text within an organization, there are few tools that allow a computer system to have a deep understanding of what the text describes.

### BRIEF SUMMARY

The present disclosure, generally described, relates to technology for automatically extracting linked node graph data structures from unstructured content.

More specifically, the technology relates to a configurable semantic natural NLP extraction platform (or system) that structures content from unstructured data to determine the sematic meaning of content and building linked node graph-based data structures from the content. Users (or clients) generate configurations for an area or topic of interest. The user may then query the system with the configuration to extract content from unstructured content. Based on the extracted content, an ontology is constructed for entities and activities, and entity objects and activity objects are identified within the unstructured content by applying a set of content extraction entity and activity rules (with respect to activity rules, the content is identified and classified, not extracted, despite the name “content extraction” rule). Application of the rules results in generation of a list of entity and activity words that satisfy the respective rules. Relationships between the entity words (and attributes) and the activity words (and attributes) are identified, and a linked data structure is formed as a linked node graph of interrelated entities and activities.

In one embodiment, there is a computer-implemented method for automatically extracting linked node graph data structures from unstructured content, including receiving a query defining a topic of interest for content extraction, the topic of interest configured using entity objects and activity objects; constructing an ontology for entities comprising the configured entity objects and an ontology for activities comprising the configured activity objects, wherein the entity objects include a set of content extraction entity rules and the activity objects include a set of content extraction activity rules for defining nodes of a linked data structure, and the entity rules and the activity rules are related to respective entity attributes and activity attributes; identifying the entity objects and the activity objects within the unstructured content by applying the set of content extraction entity rules and the set of content extraction activity rules to each word in a group of words extracted from the unstructured content, and generating a list of entity words including each of the words satisfying the entity rules and a list of activity words including each of the words satisfying the activity rules from the group of words; identifying relationships between the entity words and entity attributes and the activity words and activity attributes, the attributes connecting the entity words to an entity value different than the entity word and the activity words to an activity value different than the activity word; and generating the linked data structure as a linked node graph of interrelated entities and activities for the topic of interest from the unstructured content, wherein each node represents the entities, activities and corresponding entity and activity attributes related to the topic of interest.

In another embodiment, there are one or more computer storage mediums having computer-executable instructions embodied thereon that, when executed, performs a method of facilitating extraction of linked node graph data structures from unstructured content, the method including receiving a query defining a topic of interest for content extraction, the topic of interest configured using entity objects and activity objects; constructing an ontology for entities comprising the configured entity objects and an ontology for activities comprising the configured activity objects, wherein the entity objects include a set of content extraction entity rules and the activity objects include a set of content extraction activity rules for defining nodes of a linked data structure, and the entity rules and the activity rules are related to respective entity attributes and activity attributes; identifying the entity objects and the activity objects within the unstructured content by applying the set of content extraction entity rules and the set of content extraction activity rules to each word in a group of words extracted from the unstructured content, and generating a list of entity words including each of the words satisfying the entity rules and a list of activity words including each of the words satisfying the activity rules from the group of words; identifying relationships between the entity words and entity attributes and the activity words and activity attributes, the attributes connecting the entity words to an entity value different than the entity word and the activity words to an activity value different than the activity word; and generating the linked data structure as a linked node graph of interrelated entities and activities for the topic of interest from the unstructured content, wherein each node represents the entities, activities and corresponding entity and activity attributes related to the topic of interest.

In still another embodiment, there is a processing apparatus for automatically extracting linked node graph data structures from unstructured content, including a processing engine configured to receive a query from a client, the query defining a topic of interest for content extraction, the topic of interest configured using entity objects and activity objects; and construct an ontology for entities comprising the configured entity objects and an ontology for activities comprising the configured activity objects, wherein the entity objects include a set of content extraction entity rules and the activity objects include a set of content extraction activity rules for defining nodes of a linked data structure, and the entity rules and the activity rules are related to respective entity attributes and activity attributes; and an extractor configured to identify the entity objects and the activity objects within the unstructured content by applying the set of content extraction entity rules and the set of content extraction activity rules to each word in a group of words extracted from the unstructured content, and generating a list of entity words including each of the words satisfying the entity rules and a list of activity words including each of the words satisfying the activity rules from the group of words; identify relationships between the entity words and entity attributes and the activity words and activity attributes, the attributes connecting the entity words to an entity value different than the entity word and the activity words to an activity value different than the activity word; and generate the linked data structure as a linked node graph of interrelated entities and activities for the topic of interest from the unstructured content, wherein each node represents the entities, activities and corresponding entity and activity attributes related to the topic of interest.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures with like references indicating like elements.

FIG. 1 is an exemplary diagram of a data processing system in which aspects of the embodiments may be implemented.

FIG. 2 is an exemplary diagram of a data extractor and graph visualizer in which aspects of the embodiment may be implemented.

FIG. 3 is an exemplary flow chart of generating a lens in accordance with the systems depicted in FIGS. 1 and 2.

FIG. 4 is an exemplary linked node graph structure used to implement the process depicted in FIG. 3.

FIG. 5 is an exemplary flow chart of generating a data graph structure in accordance with the systems depicted in FIGS. 1 and 2.

FIG. 6 is an exemplary flow chart of filtering content and assembling words for execution by an operation in accordance with FIG. 5.

FIG. 7 is an exemplary flow chart of defining entity and activity rules for implementation in accordance with FIG. 5.

FIG. 8 is an exemplary flow chart of recognizing activities using triggers and attributes in accordance with FIG. 5.

FIG. 9 is an exemplary linked node graph structure generated in accordance with the implementation of FIG. 5.

FIG. 10 shows an exemplary general computer system that may be used to implement the system depicted in FIGS. 1 and 2.

### DETAILED DESCRIPTION

As used herein, the term Natural Language Processing (NLP) is the semantic and syntactic annotation (tagging) of data, typically unstructured text. Syntactic annotation is based on grammatical parts-of-speech and clause structuring. An example of syntactic tagging might be: The/determiner quick/adjective brown/adjective fox/noun. Semantic annotation is based on dictionaries that contain data relevant to the domain being parsed. An example of syntactic tagging might be: The quick brown fox/mammal Annotation (tagging) is a form of discovery. Tags are essentially a form of meta-data associated with unstructured text. An ultimate purpose of tagging is the formulation of structure (intelligence for text mining and analytics) within unstructured data or content.

The system disclosed herein is a configurable Semantic NLP Extraction platform that automatically extracts linked node graph data structures from unstructured content. These data structures enable computer systems to query and analyze the unstructured content. In one embodiment of the Semantic NLP Extraction platform, users may extract objects and graphs by configuring or extending user-defined “lenses.” Thus, the meaning of the text may be captured within the perspective of the configured topic area (lens).

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

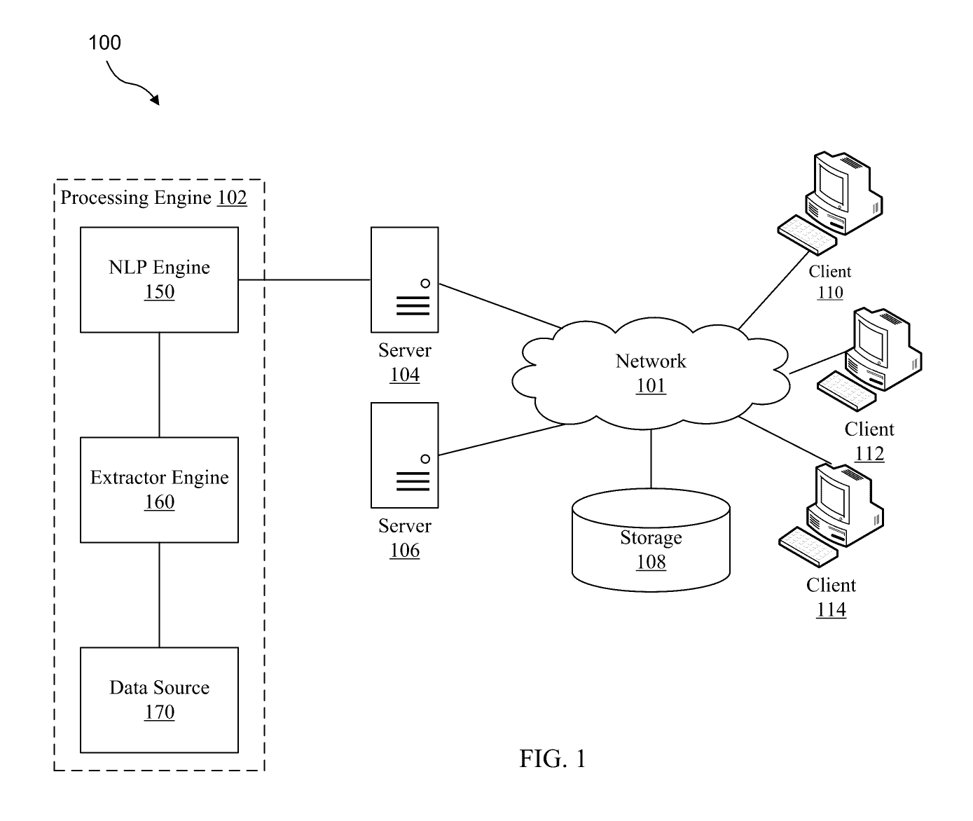

FIG. 1 is an exemplary diagram of a data processing system in which aspects of the embodiments may be implemented. Data processing system 100 may include a network of clients 110, 112, 114, servers 104 and 106, storage 108, each of which may be communicatively coupled by network 101. The network 101 may include connections, such as wired or wireless communication links, or fiber optic cables and may be any type of network. For example, network 101 may be any public or private network, or a combination of public and private networks such as the Internet, and/or a public switched telephone network (PSTN), or any other type of network that provides the ability for communication between computing resources, components, users, etc.

In the depicted example, the clients 110, 112, 114 may be, for example, personal computers, network computers, mobile devices, tablets, smartphones, PDAs or the like which may be operable by one or more users. In the depicted example, servers 104, 106 provide data, such as boot files, operating system images, and applications to clients 110, 112, 114. Clients 110, 112, 114 are clients to servers 104, 106 in the depicted example, although it is appreciated that the system is not limited to the disclosed embodiments. Moreover, data processing system 100 may include additional servers, clients, storage systems and other devices and components not shown.

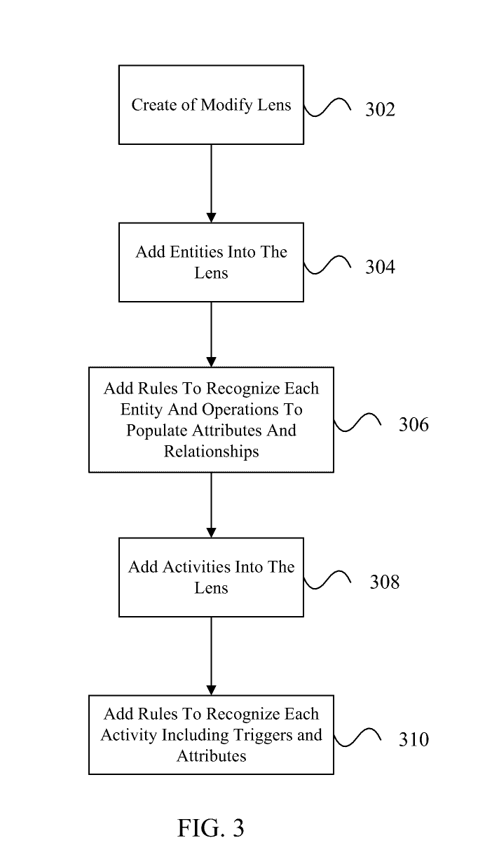

In one embodiment, the servers 104, 106 include a processing engine 102 having an NLP engine 150, extractor engine 160 and data source 170. Any one server 104, 106 may include any one or more of these components. The NLP engine 150, which may be implemented in a separate computing device or integrated into the servers 104, 106, operates on a corpus of information, such as a collection of electronic documents or the like. The NLP engine 150 may also be part of an analysis mechanism which uses natural language processing to perform analysis of a corpus of information to perform a function. In one embodiment, this analysis mechanism may be a query and response system as readily understood by the skilled artisan. In accordance with the exemplary embodiments, an extractor engine 160 may be provided in association with the NLP engine 150, either in a separate server or integrated with the NLP engine 150, which accesses the data source 170, to generate one or more text (or content) extractions for use by the NLP engine 150. Moreover, the extractor engine 160 may perform data matching, data merging, manage events and query a generated linked node graph structure to find and correlate content and information. The term “query” in this embodiment refers to a user or processing device query in which a search of the graph structure is made after text extraction from the unstructured text. Additionally, although a single data source 170 is depicted in the illustration, it is appreciated that any number of data sources may be accessible to the processing engine, either located locally or at a remote location communicatively coupled to the network 101, A further description of the implementation will be described below with reference to FIGS. 3 and 5-8.

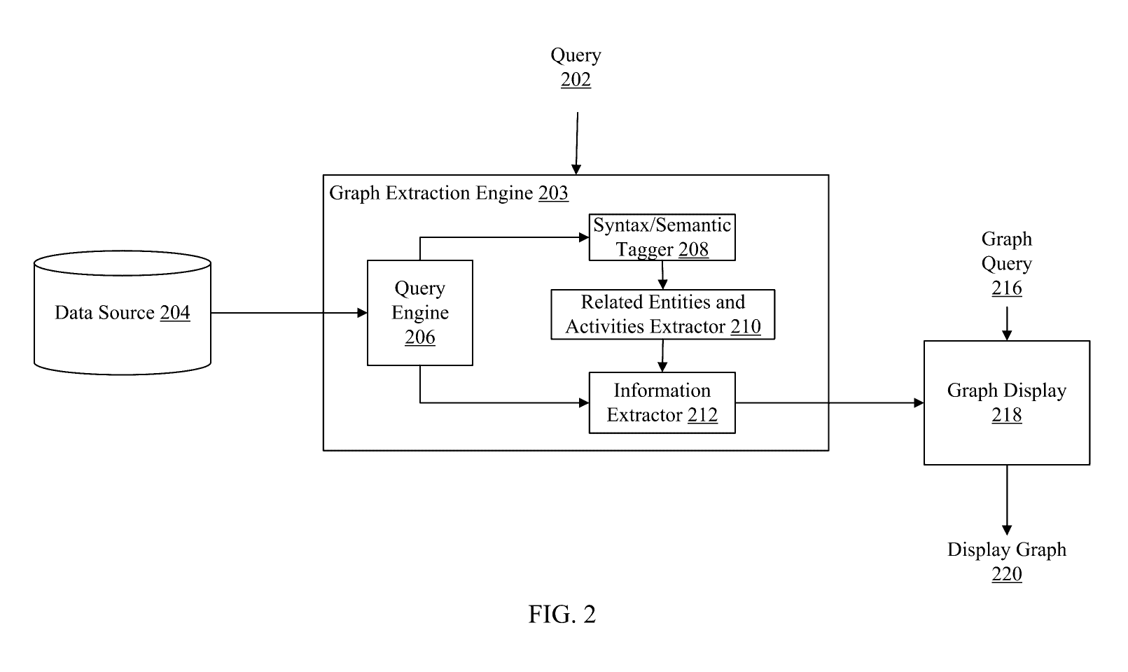

FIG. 2 is an exemplary diagram of a data extractor and graph visualizer in which aspects of the embodiment may be implemented. The system depicted in FIG. 2 may be an alternative or supplemental embodiment to the system illustrated in FIG. 1. In this embodiment, a query 202 from a client 110, 112, 114, is received by a processing device, such as server 104, 106 for a search in the unstructured data source 204. The query 202 may include an entity and/or activity, where the entity is defined as a “thing” and the activity is related to the entity and defined as “things that happen.” As explained further below, the client 110, 112, 114 may configure the system to recognize entities and activities and their relationships to each other. The configuration of the entities may be specific to a user of the client area or topic of interest.

The data source 204 may be any type of storage or storage system (and may be the same or different data source as data source 170 of FIG. 1), and includes a large number of data, such as documents, and various other forms of unstructured content. The processing device receiving the query 202 may be, but is not limited to, a graph extraction engine 203 that includes, for example, an optional query engine 206, a syntax and semantic tagger 208, related entities and activities extractor 210, information extractor 212 and relation classifier 214. These components may be part of the processing engine 102 or operate independently in communication with the processing engine 102 depicted in FIG. 1.

Query engine 206 retrieves unstructured content from the unstructured data source 204, which unstructured content may be, for example, documents containing the entity and/or activity specified in the query 202. The query engine 206 accommodates many types of user queries, from single keyword strings to full, grammatically correct sentences. If the client 110, 112, 114 enters a complete sentence, the query engine 206 has the ability to parse the sentence for syntactic and semantic information. This information deciphers the user's intention and allows for a more precise query with higher quality results. If the user enters a grammatically incorrect sentence or an incomplete sentence (i.e., a phrase), the query engine 206 attempts to map the partial fragments to known concepts. Finally, even if the user query contains only one or a few terms, the query engine is able to handle the query as a keyword-based search and return at least some results. It is appreciated that the query engine may be utilized in embodiment both when a query is made to extract content from unstructured content and when being used to search a graph structure including previously extracted content.

Semantics (and syntax) tagger 208 operate to analyze the content containing the entity and/or activity specified in the query 202 to extract various named entities and activities, lexical types and semantics of words. Specifically, words or groups of words may be tagged as a certain type—a part of speech type, sentence type, entity type, activity type, or any other type within the system. The words or word groups are not limited to a single type and may also be part of another tagged word or group of words. A related entities and activities extractor 210 extracts (or identifies and classifies) the entities, activities and relationships from tagged content that are related to the entity specified in the query 202.

An information extractor 212 extracts information from the content resulting from the search and containing the entity and activities specified in the query in order to characterize each entity, activity and relationship previously extracted. For example, for a specific entity, the people, the organizations, the locations, etc. which are related to the entity can be extracted. The information extractor 212 may continue to extract information until such time it is determined that all relations to the specified entity and/or activities have been related. The information may also be classified into predefined categories or sets of information according to their semantic meaning of the relationships.

The extracted entities, activities and relations are then represented in a linked node graph structure, discussed below. Specifically, information from the unstructured content is represented as a linked node graph structure associated with each entity, activity (when applicable) and relationship. The graph is constructed such that it facilitates the manipulation of the content. That is, the construction allows the query engine 206 (or processing engine 102) to search and extract information from the linked node graph structure. Once constructed, the graph may optionally be transmitted to a graph display 218, which may also receive additional input or a query 216 from the client 110, 112, 114 requesting or providing specific filtering criteria. For example, the client 110, 112, 114 (via the user) may request that only a specific entity and/or activities of that entity be displayed. The linked node graph is then displayed at 220.

NLP systems may also provide individual pieces of information about entities or about events considered to be attributes of the entity or event, or as relationships between two entities or events. Attributes, for example, may connect a named entity to a value that is not a named entity. Although not illustrated in the disclosed embodiments, the system may also include a component to extract such attributes, as well known in the art.

FIG. 3 is an exemplary flow chart of generating a lens in accordance with the systems depicted in FIGS. 1 and 2. At 302, the client 110, 112, 114 may create or modify the configurations using an area or topic of interest, also referred to herein as a lens. A lens, as will be discussed below in more detail, is generally defined as a configuration of content extraction for an area or topic of interest. Each lens includes at least one entity ontology and, in one embodiment, at least one activity ontology. Accordingly, a client 110, 112, 114 may configure a lens to define the “things” (e.g., entities), as well as the actions (e.g., activities) that are associated with and further define the entities. Moreover, the client 110, 112, 114 may select from a set of predefined lenses stored in a database (not illustrated), create new lenses by defining configurations for an area or topic of interest and/or modify predefined lenses or previously created lenses. Creation and modification of user-defined lenses allows different clients 110, 112, 114 to use the system 100 while providing multiple “perspectives” to a given corpora of input. Thus, clients can have the same content interpreted by the system based on specific interests. It is appreciated, that the content may also be different and that a single client may also view content from multiple perspectives.

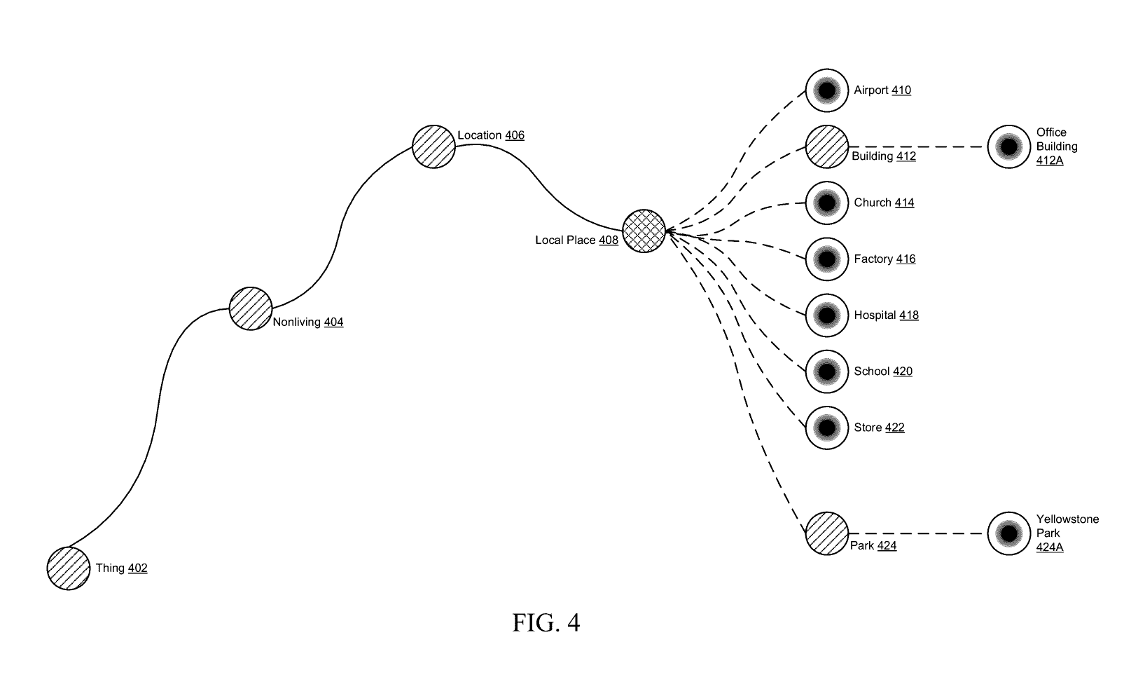

To create or modify a lens using the system 100, a client 110, 112, 114 may utilize a graphical user interface (GUI), such as a web interface, to create ontologies for entities and activities at 304. As will be explained below, each node within an ontology may contain rules for recognition and association. At 306, a client 110, 112, 114 may add rules and operations to the lens to define each entity created at 304. Entity rules enable entities to be identified differently for each lens. It is also appreciated that each lens may have multiple entity objects used to identify each entity within the lens. Upon defining the rules, the rules are associated with a node (corresponding to the entity) within an ontology. An operation, on the other hand, is a task that is performed by the processing engine 102 on the entity after is has been recognized by the rule. An example ontology and implementation is discussed with reference to FIG. 4 below.

At 308, the client 110, 112, 114 may add activities associated with the entities into the lens. Activities, as explained above, are defined as an extraction and understanding of how “things happen” as they relate to an entity. Activities ontologies are configured by the client 110, 112, 114 to extract data from text about the subject of the content. Once an activity has been added, activity rules are added by the client 110, 112, 114 at 310 to recognize each activity using the processing engine 102. Similar to entities, activity rules enable activities to be identified differently for each lens. It is also appreciated that each lens may have multiple activity objects used to identify each activity within the lens. In FIG. 4 that follows and is explained below, each of the entities and activities respectively defined by the entity and activity objects is represented by a node.

It is appreciated that in the disclosed embodiment a client 110, 112, 114 is adding the activity rules, these activity rules may also be predefined and automatically added to an activity in the lens. Moreover, each activity may contain multiple configurations.

FIG. 4 is an exemplary linked node graph structure used to implement the process depicted in FIG. 3. The process illustrated in FIG. 3 may be implemented using a GUI, such as a web interface, to configure the lens(es). As illustrated, the client 110, 112, 114 constructs an ontology for the selected lens. In the exemplary embodiment, the client 110, 112, 114 constructs the ontology via the GUI from left-to-right, beginning with selection of a “thing” (an entity) 402 as the root node in the ontology.

The client 110, 112, 114, via the GUI, further defines the root (entity) node 402, children nodes and relationships along a pathway until properties and attributes have been defined. For example, the entity node 402 has a child node 404 defined as “Nonliving” entity which has a child node 406 defined as “Location.” The location node 406 has a child node 408 defined as a “Local Place” entity with multiple children nodes 410-424 respectively defined as an airport, building, church, factory, hospital, school, store and park. Thus, in the example, the “Local Place” node is defined as an entity in which attributes may be a name and owner with inherited attributes as Latitude and Longitude (from the Location node). Parent connections include the “Location” node and child connections are defined as children nodes 410-424.

Two of the children nodes, “Building” node 412 and “Park” node 424, each have another child node, “Office Building” 412A and “Yellowstone Park” node 424, respectively. Accordingly, for “Office Building” node 412A, the node inherits attributes in the line of descent Thing node 402->Nonliving node 404->Location node 406->Local Place node 408->Building node 412->Office Building 412A. A similar line of descent is also generated for the Yellowstone Park 424A node. As appreciated, each node along the pathway is narrower or further defined by attributes from the directly connected parent node, and nodes that precede (e.g., the grandparent node, great grandparent node, etc.).

Attributes for the selected entity in the ontology may be added or removed. As noted above, attributes are values associated with the entity that may be a portion of the entity's text or another entity all together. For example, “The Office Building is made of red brick.” The entity “Office Building” could have the attribute “color” which in this sentence would be “red.” These “rules” are defined using definitions which are configured to recognize an entity or populate an attribute.

Attributes may also be inherited from the entity's parents. Nevertheless, inheriting a parent node's attributes can reduce the amount of configuration required for a lens. For example, consider the previous sentence “The Office Building was is made of red brick.” The parent node to the Office Building Node 412A is Building node 412. If the building node 412 has an attribute “color,” the entity “Office Building” may inherit the attribute definition. Likewise, any other entity that inherits from building node 412 may also inherit the rule. For example, the Local Place node 408 has children nodes 410-424. Any attribute defined for the Local Place node 408 may also be inherited by the children nodes 410-424, which may also be inherited by grandchildren nodes 412A and 424A. It is appreciated that while the disclosed embodiment discussed inheritance of attributes, nodes are not required to inherit properties and attributes and may be removed or limited as deemed necessary by users of the clients. In the illustrated example, a single path is depicted for the root node. However, it is appreciated that multiple paths may be constructed from the root node.

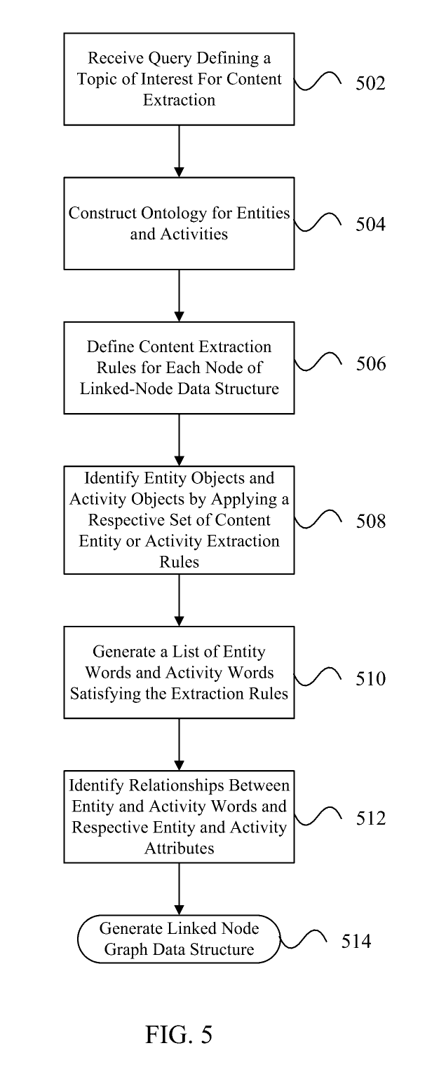

FIG. 5 is an exemplary flow chart of generating a linked node graph structure in accordance with the systems depicted in FIGS. 1 and 2. At 502, the client 110, 112, 114 queries the system via, for example, the GUI (not shown). The GUI communicates with the one or more servers 104, 106 via network 101 to facilitate processing of the unstructured contend stored in the data source 170 or 204 based on a defined area or topic of interest.

The query includes a request for content to be searched (e.g., a document, database, etc.), along with selection of a lens by the client 110, 112, 114. For example, the query may request content that is associated with Yellowstone Park, and include a selected lens, such as the exemplary lens configured in FIG. 4. The selected lens will essentially be applied by the one or more servers 104, 106 as a key to obtain configuration objects within the lens, where the objects are the configured entities (i.e., entity objects) and activities (i.e., activity objects) previously defined that will apply rules and operations against each word or group of words from the stored unstructured content.

At 504, the one or more servers 104, 106, via the processing engine 102 (or alternatively via graph extraction engine 203), begin to construct the entity and activity ontologies based on the entity and activity objects defining the selected lens. The constructed ontology may be provided for use by an application (e.g., software application) or a device (e.g., end-user hardware).

The processing engine 102 is arranged to process data (content) accessed from the data source 170, data source 204 and/or storage 108. In this example, the processing engine 102 is arranged to, using the data from the data source 170 (hereinafter, reference to data source 170 may also include or in the alternative be data source 204 and/or storage 108), automatically construct an ontology for that data. Accordingly, an ontology that formally describes relationships amongst the extracted content from the data source 170 using the requested lens(es) and search terms may be generated. Moreover, construction of the graph may be accomplished using any known ontology construction methodology.

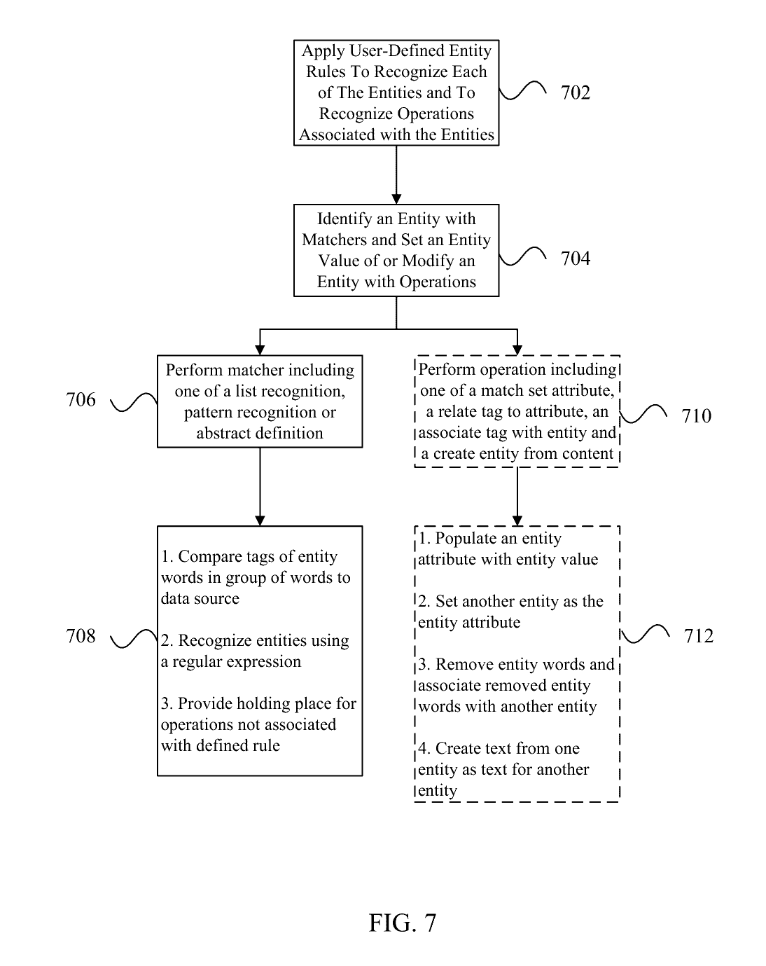

As part of constructing the ontologies at 504, content extraction rules should be defined for each node of the data structure at 506. Definitions are used to define rules to recognize an entity or populate an attribute, and are a collection of matchers and operations. A matcher may identify the entity, where each matcher may have zero or more associated operations. At least four different types of matchers may be selected: List Recognition, Pattern Recognition, Date Recognition, and Abstract. Each of the matchers are described below with reference to FIG. 7. Operations are generally used to set the value of an attribute or modify the entity. Operations are also described in greater detail below with reference to FIG. 7.

Once the content extraction rules for each node have been defined, the processing engine 102, at 508, may identify entity objects and activity objects by application of a respective set of content entity or activity extraction rules. Entity rules, as explained, are attached to a node within an ontology. The entity rules may be defined by a client 110, 112, 114 or predefined and stored in data source 170.

For example, if a lens with an entity ontology has a node (or entity) named “Vehicle” (vehicle node) a rule may be attached to that node to recognize any noun that matches the list: car, truck, airplane, train, etc. If the assigned rule is determined by the processing engine 102 to match a noun in the list, then any word that it matches is identified as a “Vehicle.” In the example, a child node (or entity) named “Car” (car node), which is linked to the vehicle node, may have a rule that matches any proper noun or groups of proper nouns to the list: Honda Accord, Honda Civic, Jeep Wrangler, F150, etc. Thus, when a word or groups of words being queried by a client 110, 112, 114 match the rule, the word or group of words will be classified by the processing engine 102 as a car. Moreover, since the car node is a child node to the vehicle node, the words or group of words are also classified by the processing engine 102 as a vehicle.

Expanding upon the example, if the line of descent in the constructed node graph for the car node is Thing->Man Made->Tangible->Vehicle->Car, the car would also be classified as all entities in the line of descent. Thus, the line of descent is instructive as to how the operations are configured for the entities.

Additionally, when a word or group of words have multiple entities that are configured such that they are in conflict with each other, entity precedence rules may be utilized by the processing engine 102. That is, entity precedence rules, which may be a subset of the entity extraction rules and stored in data source 170, may be applied in situations where a recognized word or group of words has multiple entities satisfying the entity extraction rules. For example, given the phrases “John gave the ball to April” and “We will see you on April 17,” the word “April” may be recognized by the processing engine 102 as both a human and a month. However, entity precedence rules allow a client 110, 112, 114 to define which entity takes precedence and under which circumstances. For example, an entity precedence rule could be established for the word “April” to take precedence as a month when associated with a number or followed by the word “on.”

Activity rules may also be defined by a client 110, 112, 114 or predefined rules stored in data source 170. The activity rules contain one or more triggers and attribute rules that are based on the trigger word. A trigger is a method of triggering the evaluation of an activity based on a word or group of words. A trigger can be a verb, noun, adverb, or adjective. Attribute rules are executed by the processing engine 102 from the trigger's perspective, where attributes of an activity describe the activity in greater detail and define the activity more accurately. Moreover, a valid trigger does not alone recognize an activity. Rather, the attribute rules should also be satisfied since the attribute rules detail how to recognize and populate attributes associated with an activity. If an attribute is required but is not extracted, then the activity may be invalidated by the processing engine 102.

For example, an activity “Assault” may be associated (using a rule stored in the data source 170) with a verb “hit” (the trigger word) and also require a “Victim” attribute in order to be deemed a “valid” assault. Thus, using the definition of “assault” in the sentence “John hit the ball,” the trigger word “hit” is determined to be satisfied by the processing engine 102, but the victim attribute is not determined to be satisfied by the processing engine 102. That is, the “victim” is the ball, not a person. Accordingly, the sentence is not recognized as an assault activity since the victim attribute was not satisfied (a ball cannot be a victim). In another example, the sentence “John hit Sam” would be a valid assault since it fulfills all of the defined rules—i.e., the trigger word “hit” is recognized and the victim, Sam, is a person as determined by the processing engine 102.

Attribute rules may also be inherited by parent nodes, similar to entity and activity rules, and may also be configured to override attributes from parents that would be otherwise inherited. Thus, for example, if the line of descent in a constructed node graph for an assault is Activity->Commit Crime->Assault, the attribute rule for victim could be inherited by the Commit Crime (parent) node. If the attribute rule for victim were to be changed on the Assault level, it would have to be overridden.

Attribute rules can also be configured by a client 110, 112, 114 to be extracted from a specific position in relation to the trigger. Specific position values may include subject, object, position/location, and attribute. For example, if the attribute rules for assault are defined by a client 110, 112, 114 such that the perpetrator was in the “subject” position and the victim in “object” location, then the subject is performing the trigger and the object is being performed upon by the trigger. Thus, in the sentence“John hit Sam,” John would be interpreted by the processing engine 102 as the perpetrator and Sam as the victim.

At 510, a list of entity words and activity words that satisfy the entity and activity extraction rules is generated by the processing engine 102, and relationships between the words (and their attributes) are identified by the processing engine 102 at 512. The list of entity and activity words generated by the processing engine 102 are based on the identified entity objects and activity objects by application of the extraction rules in 508. As noted above, the activity extraction rules in one embodiment identify and classify activities from the extracted content. Thus, for example, “John” may be added to the list of entity words as a perpetrator, “Sam” may be added to the list of entity words as a victim and “hit” may be identified as an activity that is classified as an activity word of “assault.” Thus, for an activity word, as opposed to an entity word, a trigger word (e.g. hit) identifies the activity that is classified (e.g., assault). The relationship(s) between the entity words and activity words and entity and activity attributes, respectively, are also identified by the processing engine 102 based on the entity and activity extraction rules defined by the client 110, 112, 114 or predefined and stored in data source 170.

At 514, a linked node graph data structure is generated by the processing engine 102 (or graph extraction engine 203). The linked node graph data structure may be generated using, for example, semantic web mapping, described below in detail. Generally, speaking, semantic maps (or graphic organizers) are maps or webs of words that visually display the meaning-based connections between a word or phrase and a set of related words or concepts.

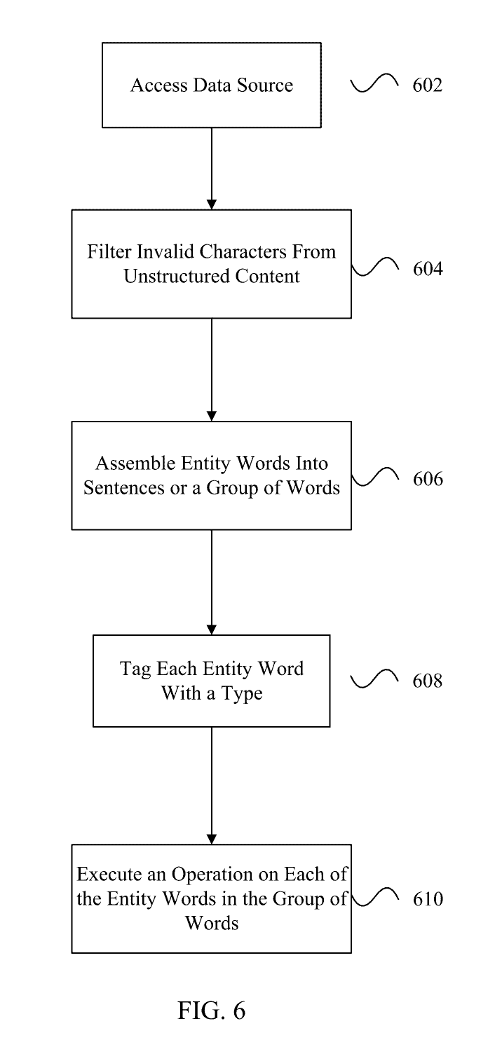

FIG. 6 is an exemplary flow chart of filtering content and assembling words for execution by an operation in accordance with FIG. 5. Specifically, the flow chart elaborates on the identification of entity objects and activity objects in 508 of FIG. 5. At 602, the processing engine 102 accesses the data source 170 to retrieve unstructured content. The unstructured content is filtered by the processing engine 102 at 604 to remove invalid or unwanted characters. For example, the processing engine 102 may filter the content to allow visible alphanumeric characters and punctuation.

At 606, the entity words previously extracted are assembled by the processing engine 102 (or graphical execution engine 203) into sentences or a group of words, and each entity word is tagged with a type (or multiple types) at 608, such as a part of speech type, sentence type, entity type, activity type or any other type within the system. The Part of Speech (POS) tagging allows words or groups of words to be categorized by grammatical properties. Entities may also be tagged as a pattern defined using a regular expression. Such tagging may also be executed by the syntax and semantic tagger 208. Statistical NLP may also be used to tag word types, word groups, entities, sentences, etc. Moreover, a rule-based NLP may be used to define a set of parameters that define an entity, word or other element within the content. NLP tagging may be accomplished, for example, using the NLP engine 150. It is appreciated that a combination of any one or more of the methodologies may be used to tag words.

After words are tagged at 608, operations are executed by the processing engine 102 on each of the entity words in the group of words at 610. Operations, as explained above, are used to set the value of an attribute or modify the entity. Operations are often associated with a matcher since details or parameters of an operation are typically dependent upon the method of entity recognition. In embodiments where this is not the case, an abstract matcher provides a holding place so that operation may be performed on an entity regardless of the method of recognition. Matchers and abstract matchers are explained below with reference to FIG. 7 that follows.

FIG. 7 is an exemplary flow chart of defining entity and activity rules for implementation in accordance with FIG. 5. The processing engine 102 (or graphical extraction engine 203) applies the entity rules to recognize each of the entities and to recognize operations associated with the entities, as explained above and not repeated herein, at 702. The processing engine 102 applies the entity rules using matchers to identify an entity, and operations set an entity value or modify an entity at 704.

Each matcher may be a different method of recognizing the entity, and may have zero or more operations associated therewith. In one non-limiting embodiment, at 706, the matchers are executed by the processing engine 102 to perform one of a list recognition, pattern recognition and abstract definition. The executed matchers perform the functions at 708, as follows.

The List Recognition Matcher is applied by the processing engine 102 to compare tags of a client 110, 112, 114 specified type against a client 110, 112, 114 specified data source, such as data source 170, in which the list may be stored. The List Recognition not only applies a list, but also tag types. For example, a client 110, 112, 114 may specify a POS tag to be matched against the stored recognition list. Using this example, if a list of plants is stored in the data source 170, the list recognition matcher may be configured to compare nouns against the list.

The Pattern Recognition Matcher is applied by the processing engine 102 to recognize entities using patterns. Patterns are typically defined using a regular expression (or regex), as understood by the skilled artisan. For example, the words “Mr. Smith” allows a client 110, 112, 114 to create a pattern that matches any “Mr.” followed by a space and a proper noun. The regular expression created may appear, for example, as: (Mr)(.)(\s+)([A-Z][a-z]+).

The Abstract Matcher is a holding place for operations that are not associated with a specific matcher that uses some sort of method of recognition.

It is appreciated that the above disclosed examples are non-limiting, and that any number of lists, patterns and abstractions may be implemented in the system.

If an entity is recognized by the processing engine 102 during the “matching” process of 706 and 708, then operations may be performed on each entity at 710. Operations are optional (and not always associated with an entity) and are performed by the processing engine 102 to execute one of a match set attribute, a relate tag to attribute, an associate tag with entity and create entity from content. The processing engine 102 executes the operations at 712, as follows.

The Match and Set Attribute operation is executed by the processing engine 102 to populate an attribute with a value. The value may be, for example, from another entity (e.g., via a line of descent), external data source, or string. For example, the match and set attribute may be set to populate an attribute with a “gender” having a type “string” with a value “male.”

The Relate Tag to Attribute operation is executed by the processing engine 102 to set other entities as attributes of the selected entity. For example, in the sentence “The red car was parked at the store,” the entity “Vehicle” could have the attribute “color,” which is “red.” If the “Vehicle” node has a parent entity named “Tangible,” which has a definition for the attribute “color,” the entity “Vehicle” could inherit the attribute definition.

The Associated Tag with Entity operation is executed by the processing engine 102 to remove elements and associate them with another entity. For example, a POS tag may be better interpreted by the processing engine 102 once other elements are removed and associated with another entity. For example, in the sentence “Captain John Smith sailed across the bay,” the words “Captain John Smith” would be recognized by the POS tagger as a collection of proper nouns. However, if the system is defined to understand that “Captain” is a rank, then the processing engine 102 may identify “John Smith” as a person. Thus, if the POS tagger of “noun” is removed and replaced with “person,” “John Smith” will be identified as a person.

The Create Entity from Text operation is executed by the processing engine 102 to create text from a matched entity as text for a specified entity.

Applying various rules and operations as described above, another example is provided. In the example, a table identifies and stores as a list of items for the list recognition rule to access for processing by the processing engine 102 is stored in data source 170. In this case, the table stores a list of items to recognize a “car” using the columns: name, manufacturer, horsepower and fuel type. An operation can also match an additional column to the entity. For example, a manufacturer attribute from a value in the table. If a line of descent (i.e., the root “Thing” node to the end “Car” node) is represented in a node graph as Thing->Man Made->Tangible->Vehicle->Car, and an operation to the node (entity) Tangible is defined to recognize the color associated with a physical object in the text, then this definition would also be inherited by the Car node. This may be accomplished using the “Relate Entity to Attribute” operation which may be configured to associate the entity color with “Tangible” or any children nodes. Thus, the phrase “red Honda Accord” would have rules to match it as a “Car,” add the attribute “Manufacturer” from a Car operation, and add the attribute “Color” from a Tangible operation.

It is appreciated that the above disclosed examples are non-limiting, and that any number of attributes, values, words and text may be implemented in the system.

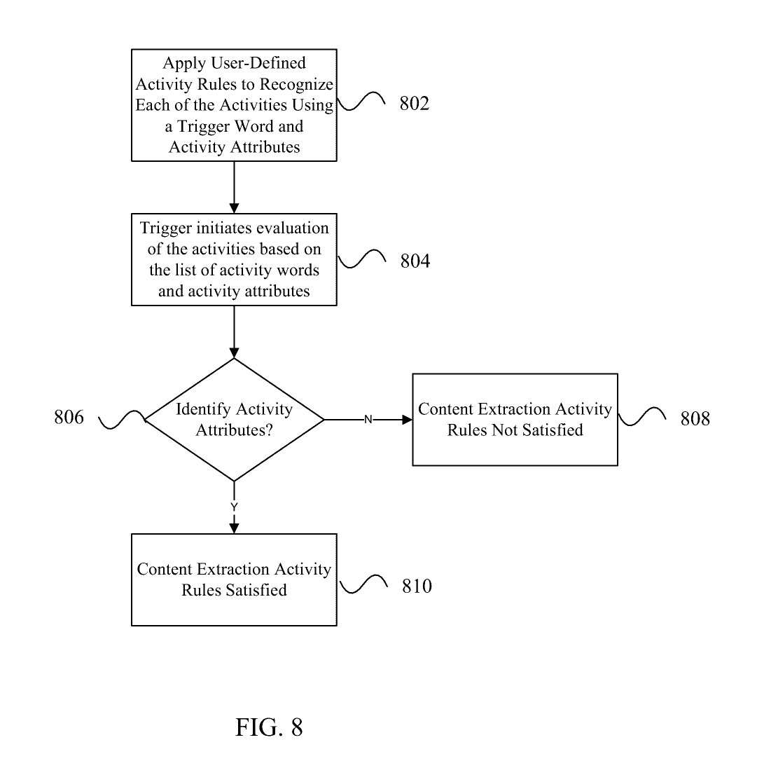

FIG. 8 is an exemplary flow chart of recognizing activities using triggers and attributes in accordance with FIG. 5. At 802, the processing engine 102 applies the activity extraction rules to recognize each of the activities using a trigger word and activity attributes. When the processing engine 102 identifies a trigger at 804, evaluation of the activities are initiated based on the list of activity words and activity attributes previously identified, as described in the above processes. The trigger may also be accompanied by a dependent word. Without a dependent word, the trigger may be invalid. For example, if the trigger is defined as “attempt,” a dependent word associated with the trigger may be “kidnapping.” Thus, the processing engine 102 may trigger the attribute rules for text that describes attempted kidnapping. However, a trigger alone is insufficient to recognize an activity, as explained above.

Similarly, a list of blacklist words may invalidate a trigger when present in content being processed. More specifically, blacklist words may be identified by the processing engine 102 during recognition of activities using a trigger word. Moreover, the blacklist words may be defined as falling into a particular position within the content. For example, a trigger for the activity “Eat Vegetables” may contain a blacklist word “failed” that is positioned (located) before the activity. Accordingly, the sentence “Jason failed to eat his broccoli” does not trigger the “Eat Vegetables” activity.

The processing engine 102 also identifies whether the activity attributes associated with the trigger are also satisfied at 806. In order for the processing engine to determine that content extraction activity rules have been satisfied at 810, the activity attributes identified should also be satisfied. Otherwise, the content extraction activity rules are determined to not be satisfied by the processing engine 102 at 808. Determining whether an activity attribute has been satisfied is implemented by the processing engine 102 using a set of attribute rules that may be stored in data source 170. Attribute rules may consist of extraction groups, entity extraction, POS extract and POS after attribute extract.

Extraction Group

Attribute rules may contain one or more extraction groups. The type of trigger in the configuration characterizes extraction groups. The rules within the extraction group are executed if the trigger detected by the processing engine 102 is the same type. For example, if the trigger type is a “verb,” then the attribute rules within a verb extraction group will be executed by the processing engine 102.

Entity Extraction

The entity extraction attribute rule matches the attribute with an entity type at a specified position from the trigger. The types of inputs are, but not limited to:

Position: Position is in reference to the trigger. A subject is the one performing the trigger, an object is “what” the trigger is being performed on, an attribute is the closest entity to the trigger and a sentence attribute is the closest thing to the trigger within the sentence.

Entities: Identification of the entities to be matched.

Entity Trigger Word: An optional setting that will not match an entity without one of the specified trigger words appearing first.

Part of Speech Extract

The POS extract attribute rule is similar to the entity extraction attribute rule. However, the rule designates matching a POS as opposed to an entity. The types of inputs are, but not limited to:

Position: Position is in reference to the trigger. A subject is the one performing the trigger, an object is “what” the trigger is being performed on, an attribute is the closest entity to the trigger and a sentence attribute is the closest thing to the trigger within the sentence.

Part of Speech: Identification of POS to be matched.

Part of Speech after Attribute Extract

The POS attribute rule is similar to POS extract, except that the rule is designated to match an entity after another attribute extracted by the activity. The inputs are, but not limited to:

Attribute: Attribute (extracted previously by entity) to be used as trigger for POS extraction.

Part of Speech: The POS tags to be matched.

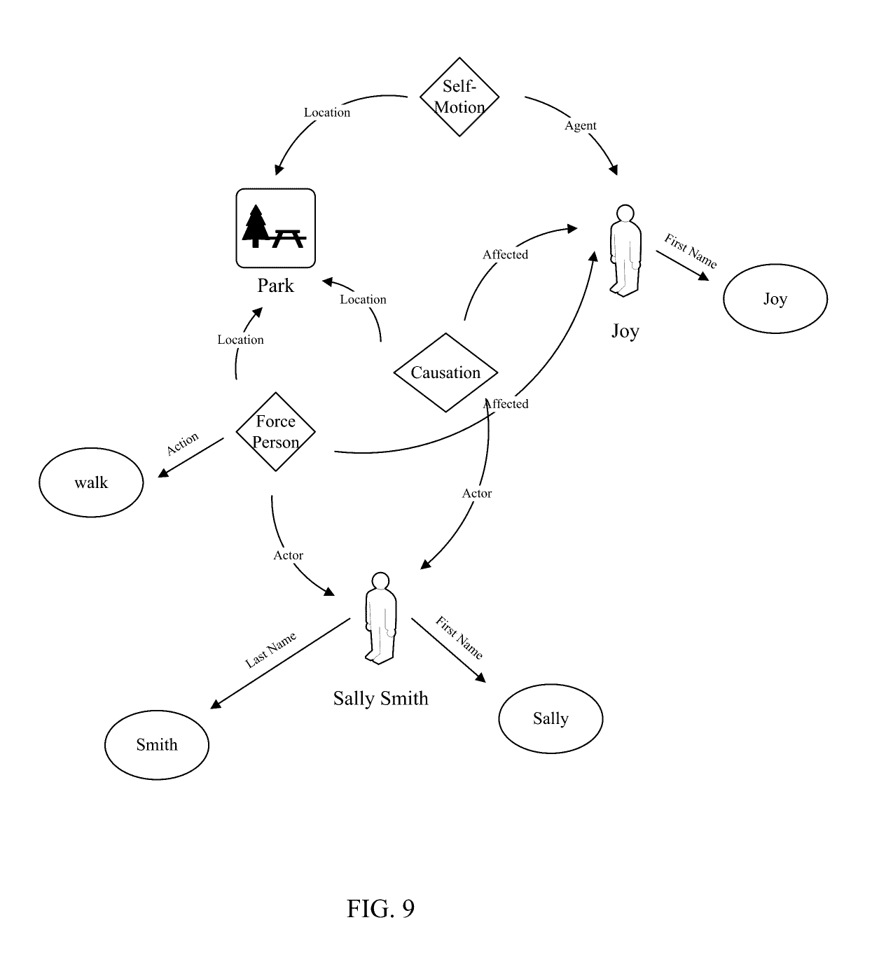

FIG. 9 is an exemplary data graph structure generated in accordance with the implementation of FIG. 5. The illustrated linked node graph data structure follows a linked structure in which children nodes may inherit rules and attributes from parent nodes, thereby reducing the amount of configuration for subtypes. A combination of lexical items and attribute rules are used by the processing engine 102 to determine the semantic meaning of the unstructured content accessed from data source 170, in accordance with the rules and processes defined above. For example, the following three sentences may be analyzed to generate a node graph structure:

1) Sally Smith made Joy walk to the park.

2) Sally Smith made Joy some cookies.

3) Sally Smith made Joy happy.

Each of the three sentences has the same lexical item, namely the verb “to make.” However, each sentence has a very different meaning. The processing engine 102 may apply the methodologies above to determine the meaning of these different sentences based on context. For example, apply configured rules specifying the following four requirements:
“To make” or “to force” as the lexical item;
Human entity in the subject position of the statement as the Actor;
Human entity in the object position of the statement as the Affected; and
Verb phrase with the Affected as the subject as the Action attribute.

Based on these rules, the processing engine 102 will determine the first sentence (sentence (1)) to have the activity “Force Person.” A word or entity in the subject position is “what” is performing the lexical item. In this example, “Sally Smith” is the entity performing the “to make.” The object position is the word or entity in which the lexical item is affecting. In this case, “Joy” is the entity affected by the lexical item. Thus, the processing engine 102 is able to determine the correct position regardless of the various ways a statement can be constructed.

The processing engine 102 (or graphical extraction engine 203) in the disclosed non-limiting embodiment utilize, for example, a semantic web to generate the graph. The semantic web uses triples, which consist of a subject, predicate, and object. To construct a graph data structure, the entities and activities are first extracted from the unstructured content. Once entities are populated from the rules found within the entity ontology in the lens, triples are constructed from the related attributes. Similarly, once activities have been extracted from the unstructured content, the activities are converted into triples. The name of the activity is the subject, the name of the attribute is the predicate, and the value of the attribute is the object. The value of an activity attribute is typically an entity, which enables the activities and entities to be related to one another. When the triples are merged together they create a group of interconnected nodes or a linked node graph data structure. Thus, the processing engine 102 automatically constructs the graph data structure from unstructured content stored in the data source 170 and based on the lens configuration. The graph can be outputted in open standard formats like RDF, N-Quads, or as JSON. It is appreciated that the graph may be represented in any appropriate format, e.g., as a diagram or as software, and is not limited to the disclosed embodiments.

The data graph structure depicted in FIG. 9 is based on the analysis of the first sentence above, namely “Sally Smith made Joy walk to the park.” As illustrated, the “Force Person” lexical item has an actor, namely Sally Smith, that causes (causation) the affected, namely Joy, to perform an action (walk) to a specific location (i.e., the park). Additional data graph structures may be output based on the second and third sentences in a similar manner.

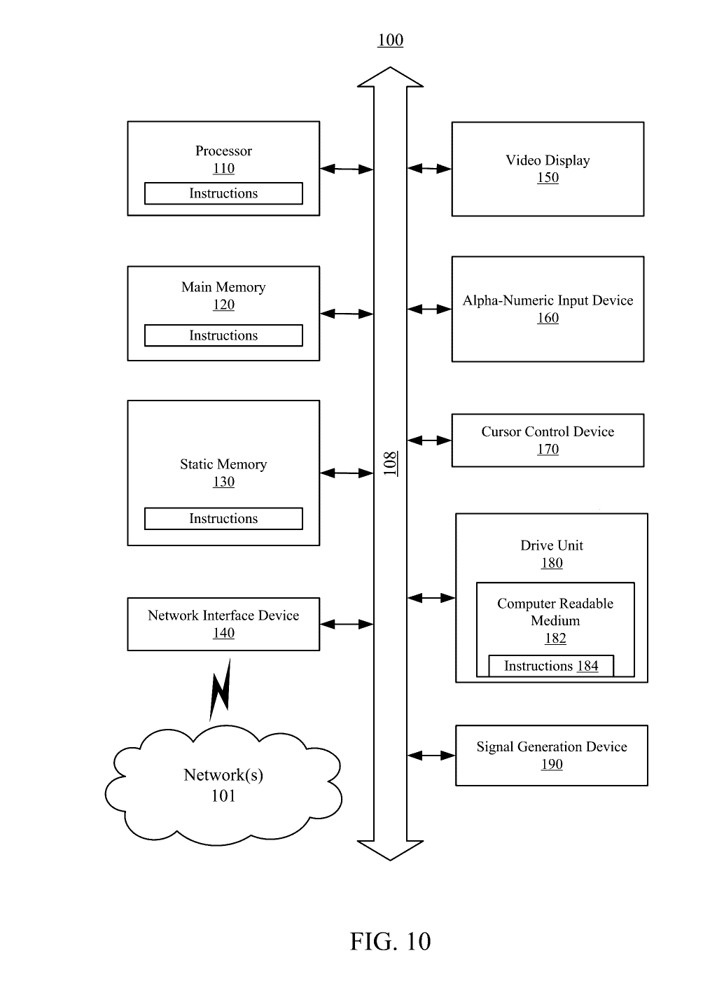

FIG. 10 is an illustrative embodiment of a general computer system. The general computer system which is shown and is designated 100 may be used to implement the systems illustrated in FIGS. 1 and 2. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as an call interceptor, an IVR, a context manager, an enrichment sub-system, a message generator, a message distributor, a rule engine, an IVR server, an interface server, a record generator, a data interface, a filter/enhancer, a script engine, a PBX, stationary computer, a mobile computer, a personal computer (PC), a laptop computer, a tablet computer, a wireless smart phone, a personal digital assistant (PDA), a global positioning satellite (GPS) device, a communication device, a control system, a web appliance, a network router, switch or bridge, a web server, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 10, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each, and processor 110, other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory describe herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 10, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for automatically extracting linked node graph data structures from unstructured content, comprising:
receiving a query defining a topic of interest for content extraction, the topic of interest configured using entity objects and activity objects;
constructing an ontology for entities comprising the configured entity objects and an ontology for activities comprising the configured activity objects, wherein the entity objects include a set of content extraction entity rules and the activity objects include a set of content extraction activity rules for defining nodes of a linked data structure, and the entity rules and the activity rules are related to respective entity attributes and activity attributes;
identifying the entity objects and the activity objects within the unstructured content by applying the set of content extraction entity rules and the set of content extraction activity rules to each word in a group of words extracted from the unstructured content, and generating a list of entity words including each of the words satisfying the entity rules and a list of activity words including each of the words satisfying the activity rules from the group of words;
identifying relationships between the entity words and entity attributes and the activity words and activity attributes, the attributes connecting the entity words to an entity value different than the entity word and the activity words to an activity value different than the activity word; and
generating the linked data structure as a linked node graph of interrelated entities and activities for the topic of interest from the unstructured content, wherein each node represents the entities, activities and corresponding entity and activity attributes related to the topic of interest.

2. The method of claim 1, wherein the query is input using an interface in communication with a processing engine to facilitate processing of the unstructured content based on the topic of interest.

3. The method of claim 1, wherein
the set of content extraction entity rules are user-defined to recognize each of the entities and the entity attributes, and
the set of content extraction activity rules are user-defined to recognize each of the activities using at least one trigger word and to recognize the activity attributes.

4. The method of claim 1, wherein the identifying the entity objects further comprises:
accessing a data source to retrieve the entity objects and the activity objects based on the topic of interest;
filtering invalid characters from the unstructured content;
assembling the entity words from the unstructured content into the one or more group of words;
tagging each of the entity words in the one or more group of words with a part of speech (POS) type and adding each of the tagged entity words to the list of entity words corresponding to the same node where the POS tag was applied, and
executing an operation on each of the entity words in the one or more group of words based on the tag and defining an order of precedence for each of the entity words.

5. The method of claim 1, wherein the entity attributes and activity attributes include at least one of a set of attributes and attributes inherited by a parent node in the linked data structure.

6. The method of claim 3, wherein
the set of content extraction entity rules are defined by one or more matchers identifying the entities and one or more operations to set the entity value of the entity attribute or to modify the entity,
the matchers perform one of a list recognition, a pattern recognition, a date recognition and an abstract definition, and
the operations perform one of a match set attribute, a relate tag to attribute, an associate tag with entity and a create entity from content.

7. The method of claim 6, wherein
the list recognition compares the tags of each of the entity words in the one or more group of words with a POS type to a data source storing syntax, semantic and morphology rules,
the pattern recognition uses a pattern to recognize entities using a regular expression comprising a string of symbols, and
the abstract definition provides a holding place for the operations not associated with a defined rule.

8. The method of claim 6, wherein
the match set attribute populates an entity attribute with the entity value,
the relate tag to attribute sets another entity as the entity attribute,
the associate tag with entity removes entity words and associates the removed entity words with another entity, and
the create entity from content creates text from one entity as text for another entity, to the evaluation failing to identify one or more of the activity attributes associated with a corresponding one of the activities, the content extraction activity rules are determined to not be satisfied.

9. The method of claim 3, wherein the at least one trigger word initiates evaluation of the activities,
in response to the evaluation identifying one or more of the activity attributes associated with a corresponding one of the activities, the content extraction activity rules are determined to be satisfied, and
in response to the evaluation failing to identify one or more of the activity attributes associated with a corresponding one of the activities, the content extraction activity rules are determined not to be satisfied.

10. The method of claim 3, wherein the set of content extraction entity rules are user-defined to recognize operations to populate at least one of the entity attributes, modify the entity value and relate entities to each other.

11. One or more computer storage mediums having computer-executable instructions embodied thereon that, when executed, performs a method of facilitating extraction of linked node graph data structures from unstructured content, the method comprising:
receiving a query defining a topic of interest for content extraction, the topic of interest configured using entity objects and activity objects;
constructing an ontology for entities comprising the configured entity objects and an ontology for activities comprising the configured activity objects, wherein the entity objects include a set of content extraction entity rules and the activity objects include a set of content extraction activity rules for defining nodes of a linked data structure, and the entity rules and the activity rules are related to respective entity attributes and activity attributes;
identifying the entity objects and the activity objects within the unstructured content by applying the set of content extraction entity rules and the set of content extraction activity rules to each word in a group of words extracted from the unstructured content, and generating a list of entity words including each of the words satisfying the entity rules and a list of activity words including each of the words satisfying the activity rules from the group of words;
identifying relationships between the entity words and entity attributes and the activity words and activity attributes, the attributes connecting the entity words to an entity value different than the entity word and the activity words to an activity value different than the activity word; and
generating the linked data structure as a linked node graph of interrelated entities and activities for the topic of interest from the unstructured content, wherein each node represents the entities, activities and corresponding entity and activity attributes related to the topic of interest.

12. The computer storage mediums of claim 11, wherein
the set of content extraction entity rules are user-defined to recognize each of the entities, and
the set of content extraction activity rules are user-defined to recognize each of the activities using at least one trigger word and to recognize the activity attributes.

13. The method of claim 11, wherein the identifying the entity objects further comprises:
accessing a data source to retrieve the entity objects and the activity objects based on the topic of interest;
filtering invalid characters from the unstructured content;
assembling the entity words from the unstructured content into the one or more group of words;
tagging each of the entity words in the one or more group of words with a part of speech (POS) type and adding each of the tagged entity words to the list of entity words corresponding to the same node where the POS tag was applied, and
executing an operation on each of the entity words in the one or more group of words based on the tag and defining an order of precedence for each of the entity words.

14. The computer storage mediums of claim 11, wherein the entity attributes and activity attributes include at least one of a set of attributes and attributes inherited by a parent node in the linked data structure.

15. The computer storage mediums of claim 12, wherein
the set of content extraction entity rules are defined by one or more matchers identifying the entities and one or more operations to set the entity value of the entity attribute or to modify the entity,
the matchers perform one of a list recognition, a pattern recognition, a date recognition and an abstract definition, and
the operations perform one of a match set attribute, a relate tag to attribute, an associate tag with entity and a create entity from content.

16. The computer storage mediums of claim 15, wherein
the list recognition compares the tags of each of the entity words in the one or more group of words with a POS type to a data source storing syntax, semantic and morphology rules,
the pattern recognition uses a pattern to recognize entities using a regular expression comprising a string of symbols, and
the abstract definition provides a holding place for the operations not associated with a defined rule.

17. The computer storage mediums of claim 15, wherein
the match set attribute populates an entity attribute with the entity value,
the relate tag to attribute sets another entity as the entity attribute,
the associate tag with entity removes entity words and associates the removed entity words with another entity, and
the create entity from content creates text from one entity as text for another entity, to the evaluation failing to identify one or more of the activity attributes associated with a corresponding one of the activities, the content extraction activity rules are determined to not be satisfied.

18. The computer storage mediums of claim 12, wherein the at least one trigger word initiates evaluation of the activities,
in response to the evaluation identifying one or more of the activity attributes associated with a corresponding one of the activities, the content extraction activity rules are determined to be satisfied, and
in response to the evaluation failing to identify one or more of the activity attributes associated with a corresponding one of the activities, the content extraction activity rules are determined not to be satisfied.

19. The computer storage mediums of claim 12, wherein the set of content extraction entity rules are user-defined to recognize operations to populate at least one of the entity attributes, modify the entity value and relate entities to each other.

20. A processing apparatus for automatically extracting linked node graph data structures from unstructured content, comprising:
a processing engine configured to receive a query from a client, the query defining a topic of interest for content extraction, the topic of interest configured using entity objects and activity objects; and construct an ontology for entities comprising the configured entity objects and an ontology for activities comprising the configured activity objects, wherein the entity objects include a set of content extraction entity rules and the activity objects include a set of content extraction activity rules for defining nodes of a linked data structure, and the entity rules and the activity rules are related to respective entity attributes and activity attributes; and
an extractor configured to identify the entity objects and the activity objects within the unstructured content by applying the set of content extraction entity rules and the set of content extraction activity rules to each word in a group of words extracted from the unstructured content, and generating a list of entity words including each of the words satisfying the entity rules and a list of activity words including each of the words satisfying the activity rules from the group of words; identify relationships between the entity words and entity attributes and the activity words and activity attributes, the attributes connecting the entity words to an entity value different than the entity word and the activity words to an activity value different than the activity word; and generate the linked data structure as a linked node graph of interrelated entities and activities for the topic of interest from the unstructured content, wherein each node represents the entities, activities and corresponding entity and activity attributes related to the topic of interest.
